(19) United States
(12) Patent Application Publication
(10) Pub. No.: US 2011/0214701 A1
(43) Pub. Date: Sep. 8, 2011

(54) Water-storage tank cleaning apparatus

(76) Inventor: Chieh Tsung Chi, Changhua City (TW)

(21) Appl. No.: 12/010,094

(22) Filed: Jan. 18, 2008

(51) Int. Cl. B08B 9/00

(52) U.S. Cl. 134/167 R

(57) ABSTRACT

A water-storage tank cleaning apparatus comprises a pivoting axle equipped with inlet passages to mount to a drain vent of a water tank with a drainpipe locked thereto. To the pivoting axle is mounted a freely-rotatable movement element that has multiple suction tubes annularly extending thereon to fluidly connect to the inlet passages respectively. The suction tube has multiple suction orifices drilled thereon and the drainpipe has the appropriate position equipped with a water-control valve matching to an IC control panel and switching on and off in multi-staged and periodical draining cycles. Therefore, when the water-control valve is rapidly shut off, the hydrodynamics generated will actuate the rotation of the suction tubes, which will stir up the mud deposited at the bottom of the water tank to be carried off and immediately discharged there-from when the water-control valve is reopened for drainage, achieving automatic cleaning of the water tank thereby.

### BACKGROUND OF THE INVENTION

The present invention relates to a water-storage tank cleaning apparatus wherein, when a water-control valve mounted to a drainpipe and set to switch on and off in periodical cycles is rapidly shut off, the hydrodynamics generated thereby will actuate suction tubes of a movement element revolving in intermittent rotation to stir up the mud deposited at the bottom of the water tank so that the disturbed mud can be immediately carried off and discharged there-from when the water-control valve is reopened for drainage, achieving automatic cleaning of the water-storage tank without interrupting the normal transport of water supply thereby.

Conventionally, a house or a building more than two stories (not referring to an apartment building and an apartment complex) usually has two cylindrical-type water tanks installed thereto wherein one is located to the floor of the building most close to the ground to receive water supply from the water pipe while the other is put to the apex of the building (usually to the top floor of the building); whereby the difference of height utilized can generate a certain water pressure so as to offer water supply to each floor of the whole building. The reason for the application of dual water tanks is also to prevent the sudden shutoff of running water so that the water tank situated close to the ground can still maintain a certain amount of water to provide the whole building with the water supply temporarily. Due to the lack of direct exposure to sunshine, the water tank located on the ground floor can avoid the growth of moss at the interior therein. However, impurities from the running water or worn-out water pipes can get accumulated and deposited at the bottom of the cylindrical-type water tank. In the long run, these dirty substances are turned into mud that must be cleaned from the water tank to ensure the quality of the running water for users in the building.

To clean the conventional cylindrical-type water tank, the water supply to the water tank must be first shut off. Then a screw shaft actuated by a motor situated at the top of the water tank must be dangled downwards to contact the bottom surface of the water tank for stirring operation thereof. After that (or at the same time), fresh water is sprinkled from the top of the water tank, and the filthy water is discharged outwards via a drainpipe disposed at the bottom of the water tank thereof. Therefore, when the water tank is being cleaned, the running water must be shut off to interrupt the water supply to the building, which is quite inconvenient to the users in daily life. Besides, a great amount of clean water is applied to flush away the mud deposited inside the water tank and, then, discharged outwards as drainage, which is very wasteful of the precious water resource.

### SUMMARY OF THE PRESENT INVENTION

It is, therefore, the primary purpose of the present invention to provide a water-storage tank cleaning apparatus wherein, when a water-control valve mounted to a drainpipe and set to switch on and off in periodical cycles is rapidly shut off in seconds, the hydrodynamics generated thereby will actuate suction tubes of a movement element revolving in intermittent rotation to stir up the mud deposited at the bottom of the water tank so that the disturbed mud can be easily carried off and discharged there-from, achieving automatic cleaning of the water-storage tank. Besides, the drainage discharged outwards can also be sufficiently used for watering plants and flowers thereby.

It is, therefore, the second purpose of the present invention to provide a water-storage tank cleaning apparatus wherein the suction tubes of the movement element are actuated by the periodical on/off switch of the water-control valve to revolve in intermittent rotation rather than to spin in rapid rotation so as to stir up the mud deposited at the bottom of the water tank; whereby, running water can still be transported from a higher water supply pipe for the users without being interrupted or drained completely off while the water-storage tank is being cleaned, efficiently saving the precious water resource thereby.

### BRIEF DESCRIPTION OF THE DRAWINGS

FIG. 1 is an exploded perspective view of the present invention.

FIG. 2 is an assembled perspective view of the present invention.

FIG. 3 is an assembled cross sectional view of the present invention.

FIG. 4 is an assembled cross sectional view of the present invention applied to a water-storage tank thereof.

FIG. 5 is a diagram showing suction tubes of the present invention titling into the best angle thereof.

FIG. 6 is a perspective view of another embodiment of the suction tube of the present invention.

FIG. 7 is a perspective view of the suction tube of the present invention having a row of brush attached to the bottom thereon.

FIG. 8 is a perspective view of another suction tube of the present invention having a row of brush attached to the bottom thereon.

FIG. 9 is a diagram showing a water-control valve of the present invention switched open for the drainage thereof.

FIG. 10 is a top side view of the present invention as shown in FIG. 9.

FIG. 11 is a diagram showing the water-control valve of the present invention shut off to stop the drainage thereof.

FIG. 12 is a top side view of the present invention as shown in FIG. 11.

FIG. 13 is an assembled cross sectional view of another embodiment of the present invention.

### DETAILED DESCRIPTION OF THE PREFERRED EMBODIMENTS

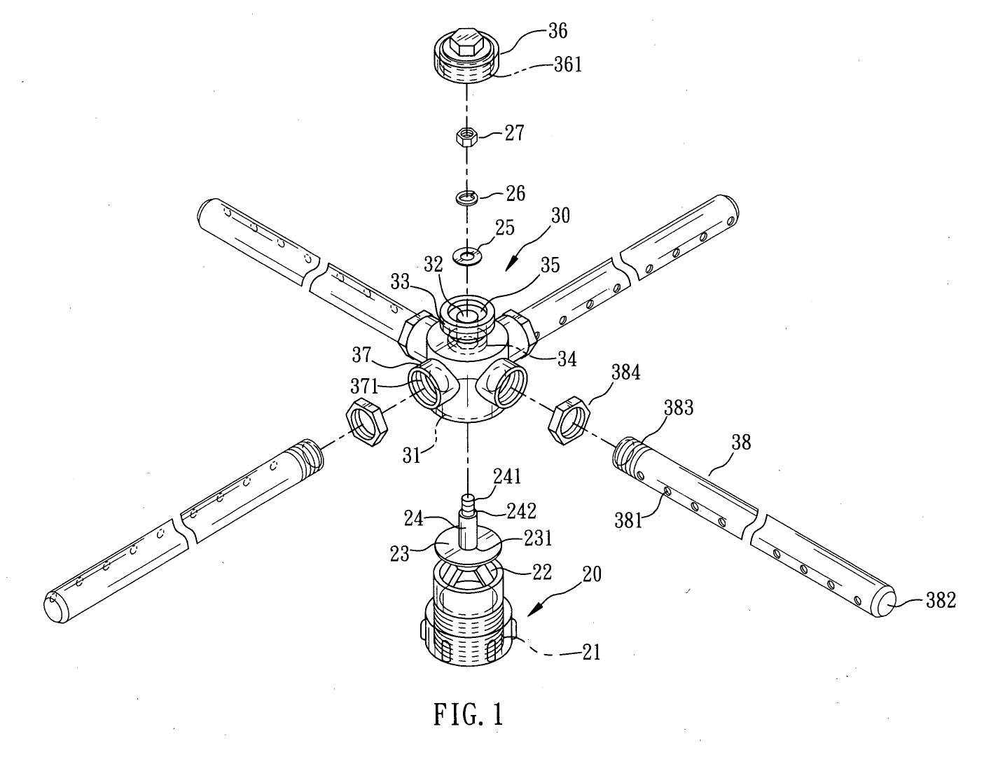

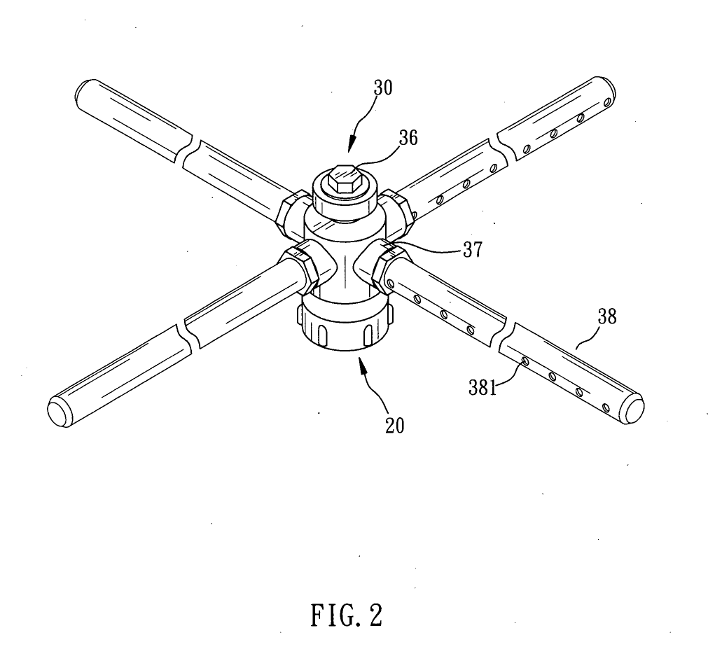

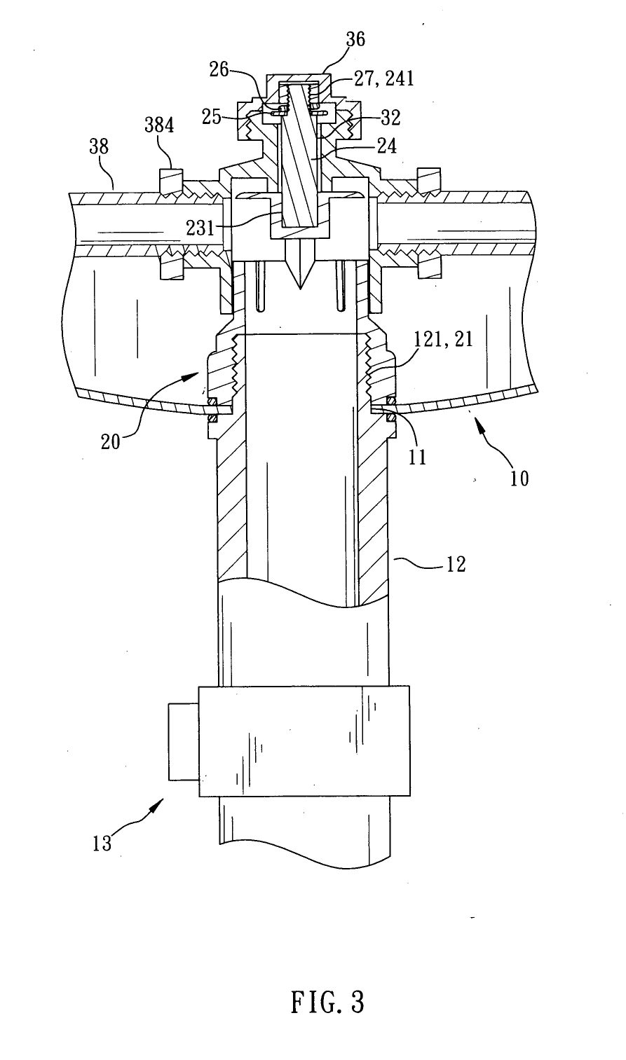

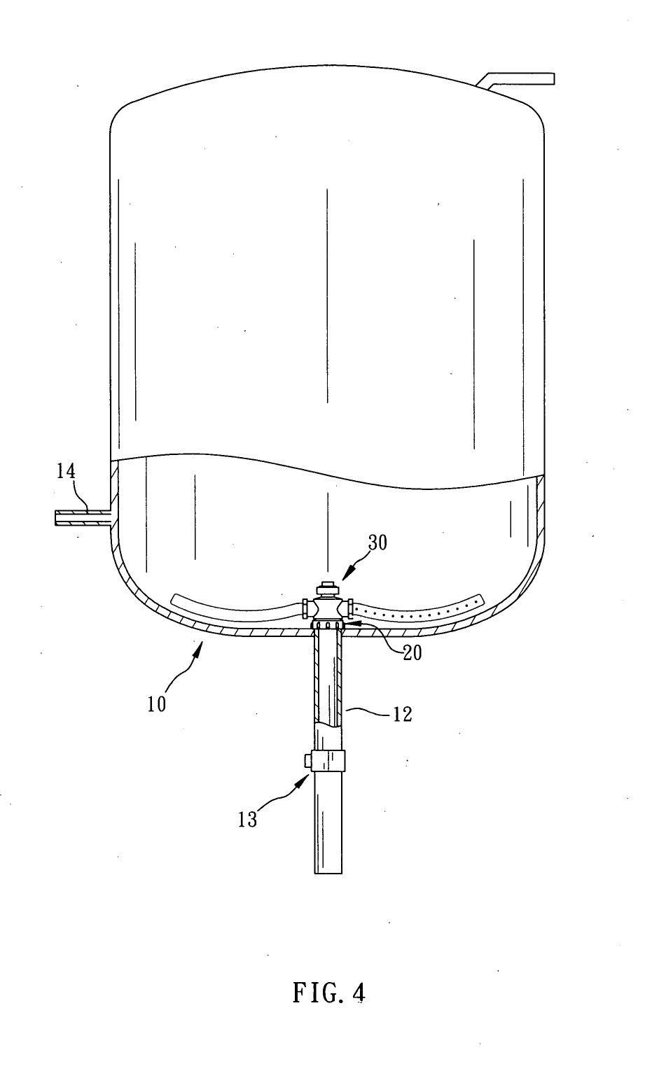

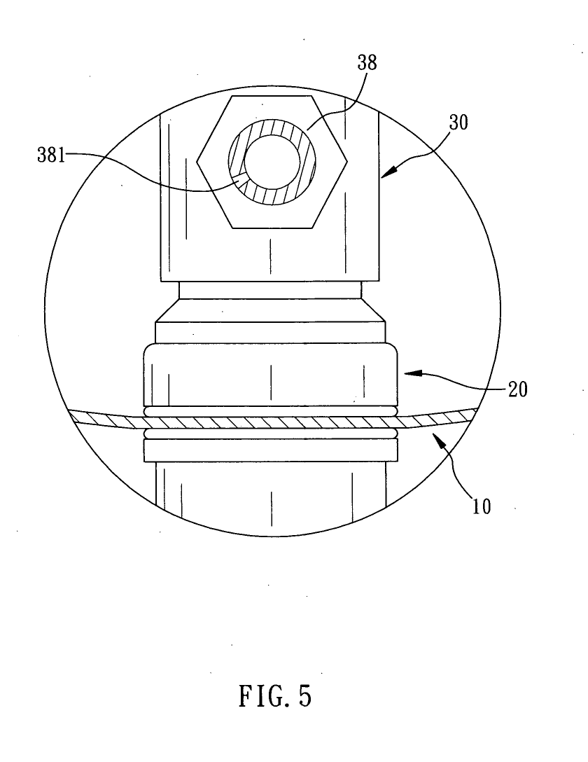

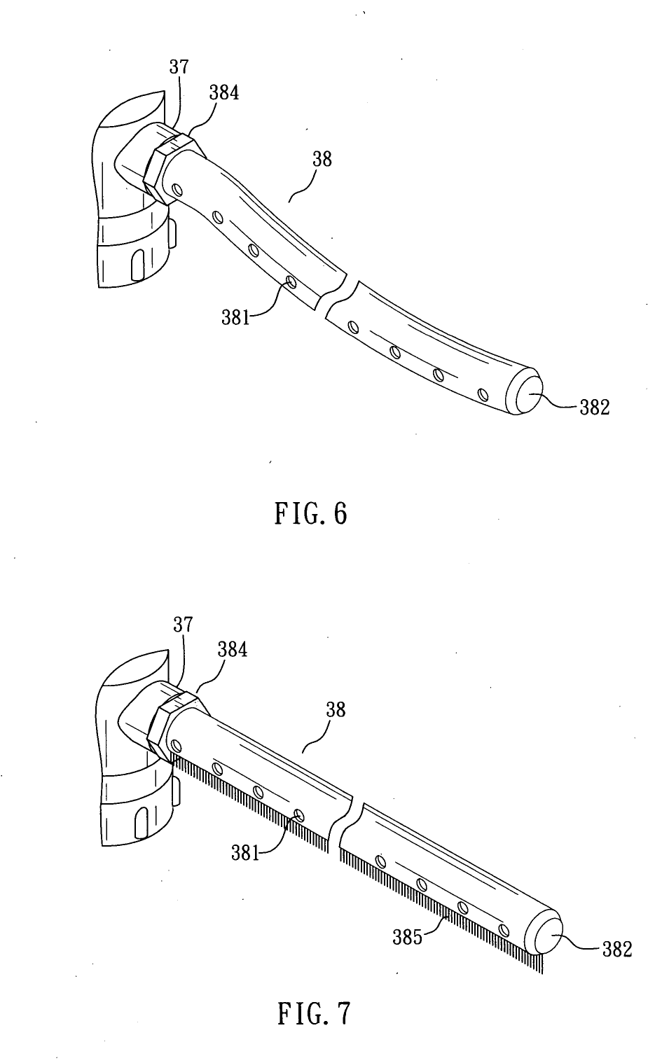

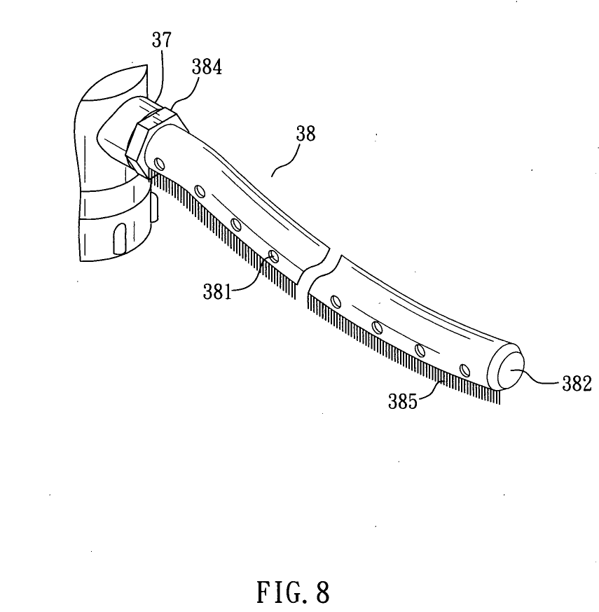

Please refer to FIGS. 1 to 4 inclusive. The present invention relates to a water-storage tank cleaning apparatus, comprising a water tank 10 having a bottom surface equipped with a drain vent 11 to which a pivoting axle 20 defined by an internal-threaded section 21 is mounted thereto. A drainpipe 12 defined by an external-threaded section 121 is guided upwards along the drain vent 11 to lock to the external-threaded section 21 of the pivoting axle 20. The drainpipe 12 has the appropriate position equipped with an electromagnetic water-control valve 13 that is matched to an IC control panel and set to switch on and off in multi-staged and periodical cycles for drainage via automatic or manual operation. The pivoting axle 20 has multiple upward-tapered supporting ribs annularly extending at the upper section thereon to form multiple inlet passages 22 to fluidly connect to the interior thereof. The top side of the pivoting axle 20 is disposed a stop seat 23 defined by a central coupling groove 231 to which a shaft 24 is mounted and located thereto. The shaft 24 has the topside equipped with a stepwise restrictive surface 242 and an outer-threaded rod 241 protruding upwards at the top thereon. A movement element 30 equipped with a pivoting cavity 31 is provided to mount to the outside of the pivoting axle 20, and the top side of the movement element 30 is disposed an external-threaded end 33 defined by a shaft bore 32, and the upper groove surface of the pivoting cavity 31 has a support section 34 extending downwards thereon to abut against the stop seat 23 thereby. The shaft 24 can be precisely guided through the shaft bore 32 to extend outwards there-from, permitting the outer-threaded rod 241 to protrude at the top of the movement element 30, to which a washer-type positioning fitting 25 and an elastic washer 26 are sequentially mounted before locked in place by a screw nut 27. The positioning fitting 25 is located to precisely abut against the restrictive surface 242. A larger-diameter groove seat 35 is disposed at the top of the shaft bore 32 and situated lower than the restrictive surface 242 so as to keep a proper distance with the positioning fitting 25 thereby. A fixing cap 36 defined by an inner-threaded section 361 is provided to secure to the external-threaded end 33 thereof, permitting the positioning fitting 25, the elastic washer 26, and the screw nut 27 thereof to hide inside the fixing cap 36 thereby. The movement element 30 also has the outer periphery equipped with multiple tubular sections 37 each defined by inner threads 371 and fluidly connecting to the pivoting cavity 31, to which a suction tube 38 with multiple suction orifices 381 arranged thereon is respectively joined and engaged therewith. The suction tube 38 has an enclosure end 382 and the other end defined by an external-threaded portion 383 with an adjusting button 384 mounted thereto to reciprocally secure to the inner threads 371 of the tubular section 37 thereby. And, the adjusting button 384 is utilized to regulate the suction orifices 381 of each suction tube 38 tilting into the identical angle; whereby, the suction orifices 381 can be switched into the best angle and kept to slant slightly downwards as shown in FIG. 5. Besides, suction tubes 38′ (referring to FIG. 6) can also be provided, which are respectively curved into an arcuate shape to match to the curvature of the bottom surface of the water tank 10 so that the suction tubes 38′ can be situated more close to the bottom surface of the water tank 10. Furthermore, the suction tube 38, 38′ can also have a row of brush 385 (referring to FIGS. 7, 8) attached to the bottom thereon and situated without contacting the bottom surface of the water tank 10 thereof.

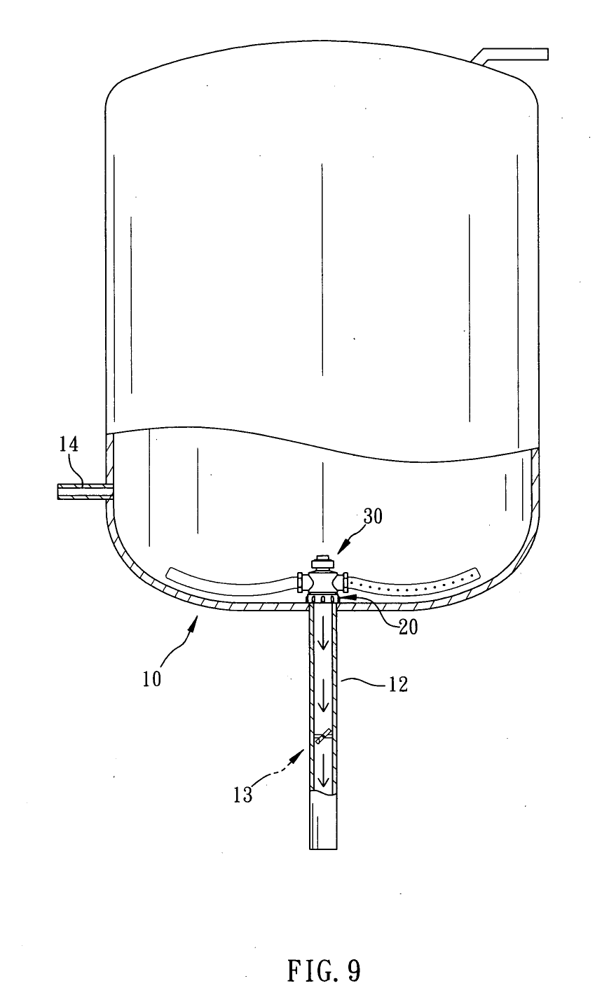

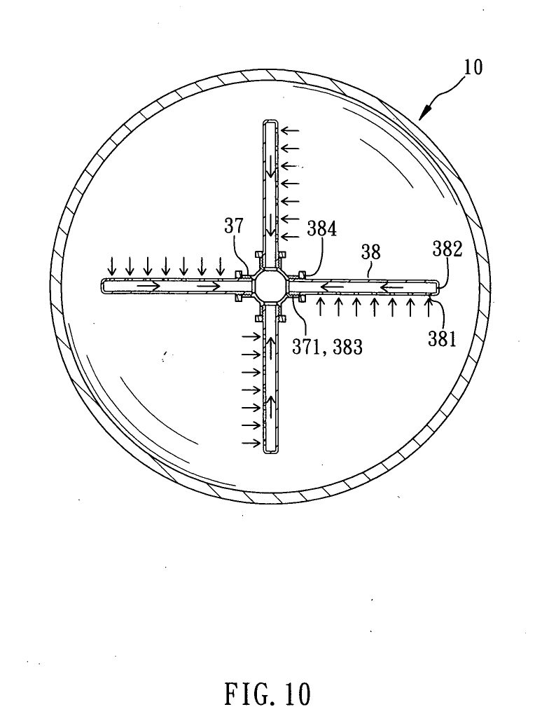

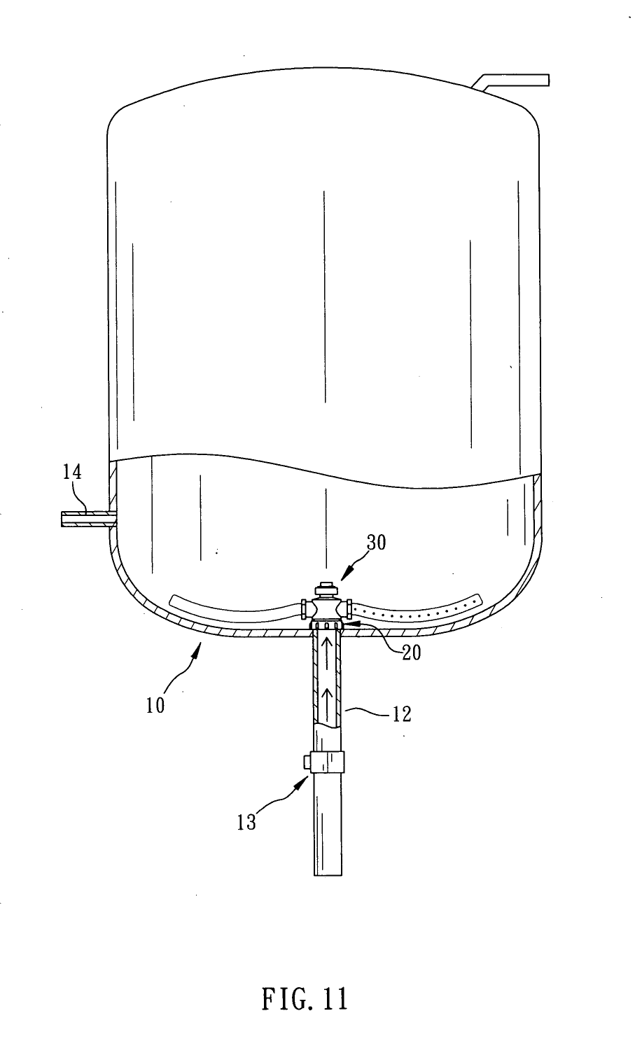

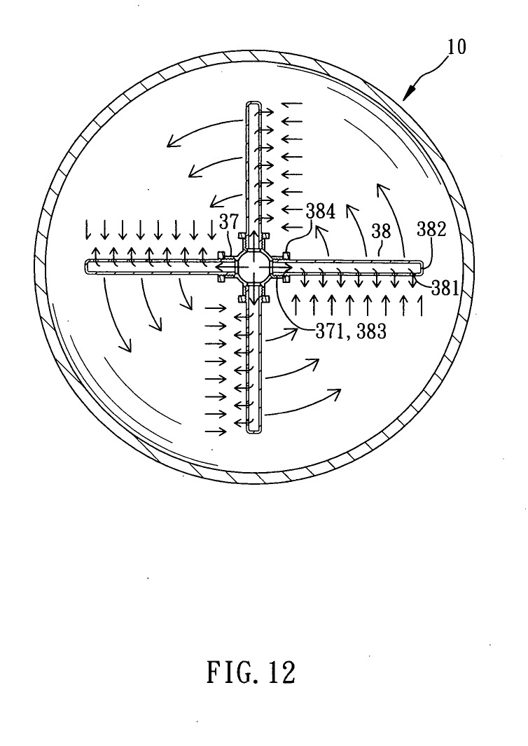

Therefore, the water-control valve 13 is set to switch on and off in multi-staged and periodical cycles for drainage thereof. When the water-control valve 13 is switched open for the drainage (referring to FIGS. 9, 10), the flow inside the water tank 10 will run through the suction orifices 381 of each suction tube 38 to enter the tubular section 37, the pivoting cavity 31, and the inlet passages 22 of the pivoting axle 20 in a sequence. Then, the flow will flush through the drainpipe 12 to be carried off and discharged outwards there-from, forming a draining pipe system thereby. When the time set for drainage is over, the water-control valve 13 will rapidly switch from the open to the close state in seconds (referring to FIG. 11). And the flow formerly running swiftly inside the drainpipe 12 will be abruptly blocked by the water-control valve 13 to stop flushing onwards. Then, the momentum of the flow will squeeze at the original flowing direction to generate a counterforce thereby. In addition, the momentum thereof will also reverberate to both sides and swell vertically towards the tubular surface thereof. Therefore, the water-control valve 13 is periodically opened and closed in cycles to alter the running speed of the flow inside the draining pipe system thereof and cause the pulsation phenomenon wherein the pressure inside the draining pipe system will abruptly rise or drop. And, the draining pipe system impacted by the great pressure will generate vibration and, accompanied by the hammering impact, the water-hammer performance will occur therein. When the flow flushes onto the water-control valve 13, the water-control valve 13 shut off can sufficiently hold the impact of the flow and exert a counterforce to the interior of the water tank 10, indirectly causing the pressure inside the draining pipe system to rise abruptly and generate a reflux force therein. Then, the flow inside the draining pipe system will run backwards through each suction orifice 381 of the suction tube 38 to return to the interior of the water tank 10 as shown in FIG. 11. Meanwhile, the returned flow through each suction orifice 381 will impact the water accommodated inside the water tank 10. And the water pressure inside the water tank 10 is larger than that of the returned flow passing through the suction orifices 381 thereof, which will generate a counterforce sufficient to push the suction tubes 38 thereby. Then, the shaft bore 32 of the movement element 30 actuated by the pushing force of the suction tubes 38 will rotate around the shaft 24 thereof. Meanwhile, the pivoting cavity 31 has the support section 34 extending therein to abut against the stop seat 23 so as to reduce the resistance of friction and allow the movement element 30 to smoothly activate the rotation of the suction tubes 38 therewith. The revolving suction tubes 38 are utilized to stir up the mud deposited at the bottom of the water tank 10, permitting the mud to float upwards thereby. Then, when the water-control valve 13 is reopened, the disturbed mud can be easily carried off from the bottom of the water tank 10 to go through the suction orifices 381, the pivoting cavity 31, and the inlet passages 22 sequentially before discharged outwards through the drainpipe 12 thereby. Therefore, the water-control valve 13 is set to switch periodically on and off in intermittent cycles, permitting a water hammer performance to naturally occur in the draining pipe system thereof. And the hydrodynamics generated thereby is utilized to actuate the suction tubes 38 revolving and exerting one-in-and-one-out sucking forces onto the fluid accommodated at the bottom of the water tank 10 so as to accurately stir up the deposited mud to be rapidly discharged outwards when the water-control valve 13 is reopened for drainage thereof. Therefore, the water tank 10 of the present invention can achieve automatic cleaning operation to avoid the inconvenience of the half-machine and half-labor cleaning process of the aforementioned conventional water tanks. In addition, the drainage discharged can also be recycled and applied to water flowers and plants, facilitating the best use of the precious water resource thereby. Meanwhile, the suction tubes 38 are actuated by the periodical on/off switch of the water-control valve 13 to revolve in intermittent rotation for stirring up the mud deposited at the bottom of the water tank 10 rather than to spin in rapid rotation. Therefore, fresh water accommodated inside the water tank 10 can still be transported outwards via a higher water supply pipe 14 without being interrupted by the cleaning process thereof. So, the water supply for users can be kept to run in a normal state without being completely drained off for the cleaning as found in the conventional water cleaning apparatus mentioned above, economically saving the precious water resource thereby.

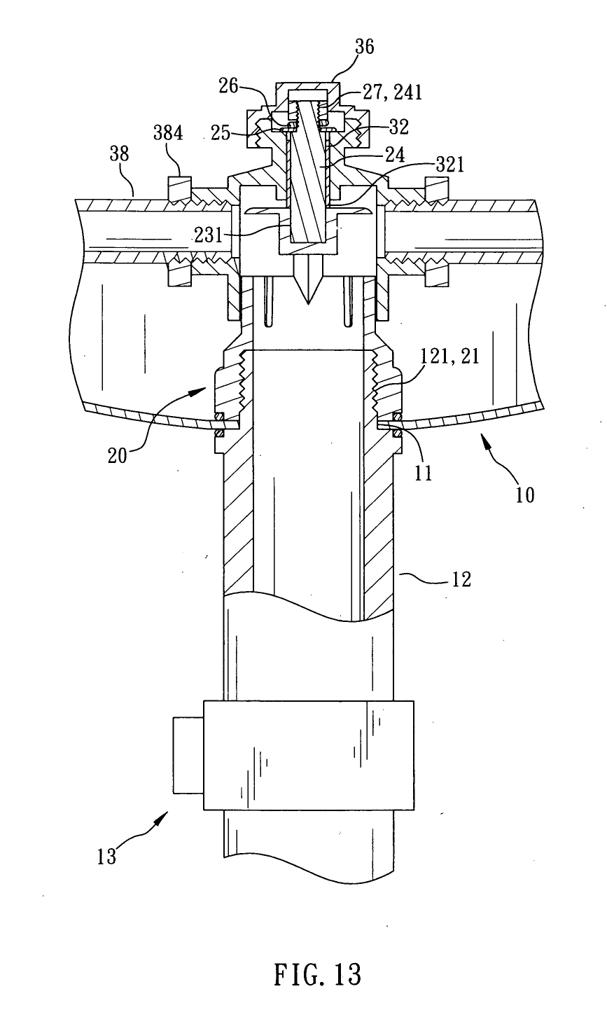

Please refer to FIG. 13. The shaft 24 of the pivoting axle 20 can be molded in metallic material, and the shaft bore 32 of the movement element 30 can also have a metallic shaft sleeve 321 mounted thereto. The shaft sleeve 321 has a bottom end slightly extending out of the shaft bore 32 to abut against the stop seat 23 so as to reduce the contact area between the stop seat 23 and the support section 34 thereof and allow more smooth rotation of the movement element 30 thereby. Meanwhile, the groove seat 35 is restricted by the positioning fitting 25 so that the movement element 30 can avoid being affected by the buoyancy of the fluid inside the water tank 10 and floating upwards to detach from the shaft 24 thereof. In addition, to cut down the resistance to the rotation of the suction tubes 38 inside the water tank 10, the suction tubes 38 can also be molded into a flat shape respectively so as to efficiently reduce their cross sectional areas in the rotating movement thereby.

What is claimed is:

1. A water-storage tank cleaning apparatus wherein a pivoting axle equipped with inlet passages is mounted to a drain vent disposed at the bottom of a water tank to fluidly connect to a drainpipe; the pivoting axle has a freely-rotatable movement element mounted thereto, and the movement element has multiple suction tubes annularly extending at the outer periphery thereon to fluidly connect to the inlet passages of the pivoting axle respectively; besides, the suction tube has multiple suction orifices drilled at one side thereon; the drainpipe also has the appropriate position equipped with a water-control valve that is switched periodically on and off via an IC control panel and set to multi-staged and intermittent draining cycles in an automatic or manual operation; therefore, when the water-control valve is rapidly shut off in seconds, the hydrodynamics is utilized to cause the rotation of the suction tubes so that the mud deposited at the bottom of the water tank can be disturbed to float upwards; then, the disturbed mud can be immediately carried off and discharged outwards there-from when the water-control valve is reopened for drainage thereof; therefore, depending on the periodical on/off switch of the water-control valve, the suction tubes are naturally actuated to revolve in intermittent rotation for stirring up the mud deposited at the bottom of the water tank rather than to spin in rapid rotation; whereby, fresh running water can still be transported outwards via a higher water supply pipe without being interrupted by the cleaning process thereof, and the water supply for users can be kept to run in a normal state without being completely drained off for the cleaning as found in the conventional water cleaning apparatus, economically saving the precious water resource thereby.

2. The water-storage tank cleaning apparatus as claimed in claim 1 wherein the pivoting axle and the drainpipe can be respectively equipped with an internal-threaded section and an external-threaded section, which are reciprocally locked to each other thereby.

3. The water-storage tank cleaning apparatus as claimed in claim 1 wherein the water-control valve can be composed of an electromagnetic valve thereof.

4. The water-storage tank cleaning apparatus as claimed in claim 1 wherein the pivoting axle has multiple upwards-tapered supporting ribs annularly extending at the upper section thereon to form multiple inlet passages, and the top side having a stop seat with a central coupling groove defining thereon to which a shaft is mounted and located thereto; the shaft has the topside equipped with a stepwise restrictive surface and an outer-threaded rod protruding upwards at the top thereof; the movement element is defined by a pivoting cavity therein to mount to the outside of the pivoting axle thereby; besides, the topside of the movement element is disposed an external-threaded end defined by a shaft bore, and the upper groove surface of the pivoting cavity has a support section extending downwards thereon to abut against the stop seat thereby so that the shaft can be precisely guided through the shaft bore to extend outwards there-from, and the outer-threaded end is allowed to protrude at the top of the movement element, to which a washer-type positioning fitting and an elastic washer are sequentially mounted and locked in place by a screw nut wherein the positioning fitting is mounted to precisely abut against the restrictive surface, and a larger diameter groove seat is disposed at the top of the shaft bore and located lower than the restrictive surface so as to keep a proper distance with the positioning fitting thereof; in addition, a fixing cap defined by an inner-threaded section is provided to secure to the external-threaded end thereof, permitting the positioning fitting, the elastic washer, and the screw nut thereof to hide inside the fixing cap thereby.

5. The water-storage tank cleaning apparatus as claimed in claim 1 wherein the movement element also has the outer periphery equipped with multiple tubular sections each defined by inner threads to connect to a suction tube thereby; the suction tube has an enclosure end and an external-threaded portion with an adjusting button mounted thereto disposed at the other end thereof, which can be secured to the inner threads of the tubular section and regulated to adjust the angle of the suction orifices disposed at the suction tube thereon.

6. The water-storage tank cleaning apparatus as claimed in claim 1 wherein the suction tubes can be arched into an arcuate shape to match to the curvature defining the bottom surface of the water tank thereby.

7. The water-storage tank cleaning apparatus as claimed in claim 1 wherein the suction tube can also have a row of brush attached to the bottom thereon and situated without contacting the bottom surface of the water tank thereof.
